(19) United States
(12) Patent Application Publication
(10) Pub. No.: US 2008/0245580 A1
(43) Pub. Date: Oct. 9, 2008

(54) Scale including a removable display

(76) Inventors: Gregoire B. Aby-Eva, Pittsburgh, PA (US); Eric R. Colburn, Wexford, PA (US); Conor P. McNamara, Brooklyn, NY (US)

Correspondence Address: SEYFARTH SHAW LLP, 131 S. DEARBORN ST., SUITE 2400, CHICAGO, IL, 60603-5803, US

(21) Appl. No.: 11/732,872

(22) Filed: Apr. 5, 2007

(51) Int. Cl. G01G 21/28

(52) U.S. Cl. 177/25.12

(57) ABSTRACT

A scale including a housing having a weight sensor wherein the weight sensor is adapted to determine a weight of an item placed on the weight sensor. The housing also defines an internal compartment having a guide wall and a guide post. Additionally, the scale includes a display that communicates with the weight sensor and is removably attached to the housing, and a cord connecting the display and the housing. The guide wall and the guide post control the movement of the cord in and out of the housing when the display is moved between an extended position and a retracted position.

### BACKGROUND

There are a variety of scales that are used to measure the weight of a particular object or objects. In grocery stores, scales are used to measure produce at a checkout counter. Scales are also used in homes by persons to measure their body weight or the weight of household items. There are also relatively large scales for measuring larger objects, such as trucks. Most of these scales include some sort of platform or surface which supports the item, object or person being weighed. Typically, a sensor is coupled to the platform and senses the weight of the item, object or person on the platform. The sensor communicates the sensed weight as electrical signals to a display which visually shows the weight of the item, object or person, that is on the scale.

Most scales include a display that is integrally attached to the housing. These displays, however, can not be moved or turned to provide different viewing angles of the displays. Thus, a person must stand directly in front of the scales having these types of displays or relatively close to these scales to be able to adequately view the display on the scale. Some known scales have a display which is positioned on a tray that is slidably attached to the housing. The tray and display are moved and/or rotated with respect to the housing to provide different viewing angles of the display. The viewing angles, however, are limited by the range of motion of the tray which is still attached to the housing.

Other scales have a movable display which slides and/or pivots to allow the display to be viewed from different angles. Furthermore, some scales have removable displays which can be separated from the housing of the scale, while still maintaining communication with the scale by either an electrical cable or a cord, so that a user can move about and view the display from virtually any angle or position in relation to the scale.

The electrical cords on the removable displays, however, can become tangled or crimped, as the cord moves in and out of the housing when the display is attached and removed from the housing. For example, longer cords can cross over themselves as they move in and out of the housing so that the cord gets tangled, which makes it is difficult to move the cord in and out of the housing. The cord may also become crimped, severed or damaged, as the cord moves in and out of the housing due to the friction between the cord and the edges of the housing that are adjacent to the opening that the cord moves through. Such problems can make it difficult to use the display or cause the display to malfunction or not work at all.

Accordingly, there is a need for an improved scale which has a housing and a removable display that is easily moved into and out of the housing and which can be secured to the housing.

### SUMMARY

The present invention is directed to a scale, and more specifically, to a food scale, which has a removable display that is attachable to the housing using at least one connector, such as a magnet, that is attracted to the housing.

One embodiment provides a scale including a housing having a weight sensor, where the weight sensor is adapted to determine a weight of an item placed on the weight sensor. The scale includes a display that communicates with the weight sensor and is removably attached to the housing. The display is adapted to display the weight of the item. The display includes at least one connector, where the connector is attached to the housing to secure the display to the housing.

In an embodiment, the housing includes a wireless signal generator and the display includes a wireless signal receiver, where the wireless signal generator generates a signal corresponding to the weight of the item and the wireless signal receiver receives the signal and displays the weight of the item.

In an embodiment, the scale includes a cord connected to the weight sensor and the display.

In an embodiment, the display includes an indicator which indicates when the weight of the item nears a designated weight.

In an embodiment, the display includes an indicator which indicates when the weight of the item exceeds a designated weight.

In an embodiment, the item is a food item.

In an embodiment, the connector includes at least one magnet that is attracted to the housing.

In an embodiment, the connector and the housing each include at least one magnet, where the magnet of the connector is attracted to the magnet of the housing.

Another embodiment provides a scale including a housing having a weight sensor adapted to determine a weight of an item placed on the weight sensor. The housing defines an internal compartment and includes at least one guide post and at least one guide wall in the internal compartment. The scale includes a display that is removably attached to the housing. The display is adapted to display the weight of the item and is movable between an extended position and a retracted position. A cord is connected to the housing and the display to communicate signals between the housing and the display. The guide post and the guide wall are configured to help guide the cord when the display is moved between the extended position and the retracted position and to prevent crimping of the cord. The cord is stored in the internal compartment when the display is in the retracted position.

In an embodiment, the display includes an indicator which indicates when the weight of the item nears a designated weight.

In an embodiment, the display includes an indicator which indicates when the weight of the item exceeds a designated weight.

In an embodiment, the item is a food item.

In an embodiment, the display includes at least one magnet that is attracted to the housing.

In an embodiment, the display and the housing each include at least one magnet, where the magnet of the display is attracted to the magnet of the housing.

A further embodiment provides a scale including a housing having a weight sensor. The weight sensor is adapted to determine a weight of an item placed on the weight sensor. The scale also includes a display that communicates with the weight sensor and is removably attached to the housing. The display is adapted to display the weight of the item and includes an indicator which indicates a relationship between the weight of the item and a designated weight.

In an embodiment, the housing includes a wireless signal generator and the display includes a wireless signal receiver, wherein the wireless signal generator generates a signal corresponding to the weight of the item and the wireless signal receiver receives the signal and displays the weight of the item.

In an embodiment, the indicator indicates when the weight of the item exceeds the designated weight.

In an embodiment, the item is a food item.

In an embodiment, the display includes at least one magnet that is attracted to the housing.

In an embodiment, the display and the housing each include at least one magnet, where the magnet of the display is attracted to the magnet of the housing.

It is therefore an advantage of the present invention to provide a scale which has a removable display that can be moved to several different viewing positions.

Another advantage of the present invention is to provide a scale which has a removable display that can be easily removed and re-attached to the housing.

A further advantage of the present invention is to provide a scale having a housing, a removable display and a cable connecting the housing and the display, where the housing configuration controls the movement of the cord in and out of the housing to help prevent the cord and the display from being damaged during use.

Another advantage of the present invention is to provide a scale having a housing and a removable display that includes at least one magnet where the magnet is attracted to the housing to help secure the display to the housing.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is a perspective view of an embodiment of a scale having a removable display where the display is positioned adjacent to the housing.

FIG. 2 is a bottom view of the scale of FIG. 1.

FIG. 3 is a fragmentary top view of the scale of FIG. 1 with the top panel of the housing removed.

FIG. 4 is a perspective view similar to FIG. 1 showing the display removed from the housing.

FIG. 5 is an enlarged top view of the scale with the display attached to the housing and with the weight sensor and display screen removed, and with a different cord protector.

FIG. 6 is a reduced view similar to FIG. 5 with the display removed from the housing.

FIG. 7 is a view similar to FIG. 4 illustrating a wireless embodiment.

### DETAILED DESCRIPTION

The present invention is directed to a scale, and more specifically, to a food scale for measuring a weight of one or more different food items. The food scale includes a removable display that can be moved to a number of different viewing positions.

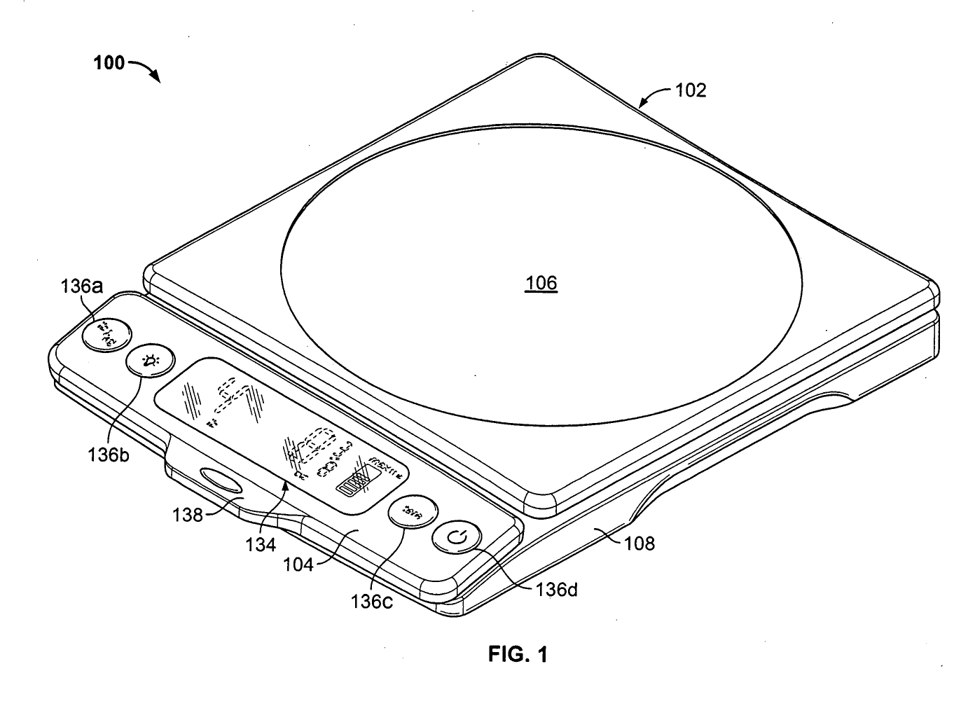

Referring now to FIGS. 1-6, the scale, such as food scale 100, includes a housing 102 and a display 104 that is removably attached to the housing. The removable display 104 enables the user to view the weight of a particular food item placed on the scale at a number of different positions and/or from a number of different angles.

The housing 102 includes a weight sensor 106 connected to a base 108. The weight sensor 106 senses the weight of the food item or items placed on the scale by being vertically displaced due to the weight or weights of the items. Generally, the amount of vertical displacement of the sensor determines the weight read by the sensor. The displacement amount is converted to a signal such as an electrical signal which is communicated from the sensor to the display 104 as described below. In an embodiment, the weight sensor includes a platform (not shown) on which one or items are placed to be weighed. It should be appreciated that the weight sensor 106 may be any suitable weight sensor, weight sensing device or weight sensing assembly, including force or pressure-responsive or other non-movable devices. It should also be appreciated that the housing 102 may be any suitable size or shape.

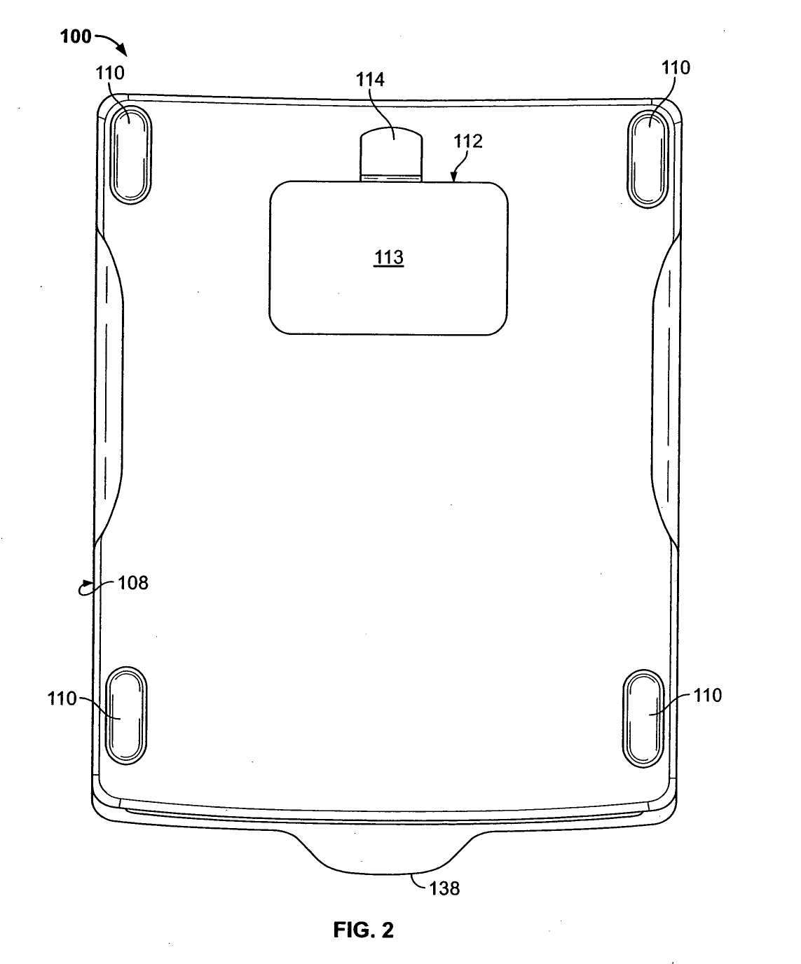

In an embodiment, the weight sensor 106 sits on a base 108 which supports the weight sensor and other internal components of the food scale. As shown in FIG. 2, the base 108 includes at least two supports or feet 110. The feet 110 help to stabilize the scale. In an embodiment, the feet 110 are made of a non-slip material, such as rubber. It should be appreciated that the feet may be made of any suitable material or combination of materials that help minimize or prevent the food scale from moving or sliding on an underlying surface.

In the illustrated embodiment, the base 108 also includes a battery compartment 112, which stores one or more batteries to provide power to the food scale. The battery or batteries are positioned in and connected to the food scale in the battery compartment 112. A lid 113 is placed on the compartment 112 until tab 114 engages a corresponding slot (not shown) formed in the housing. The lid 113 covers the battery compartment 112 to prevent the battery or batteries from falling out of the housing or from being removed from the housing. To release the lid 113 from the battery compartment 112, a user presses or pulls on release tab 114 to release and remove the lid 113. It should be appreciated that one or more batteries may be used to provide power to the food scale 100.

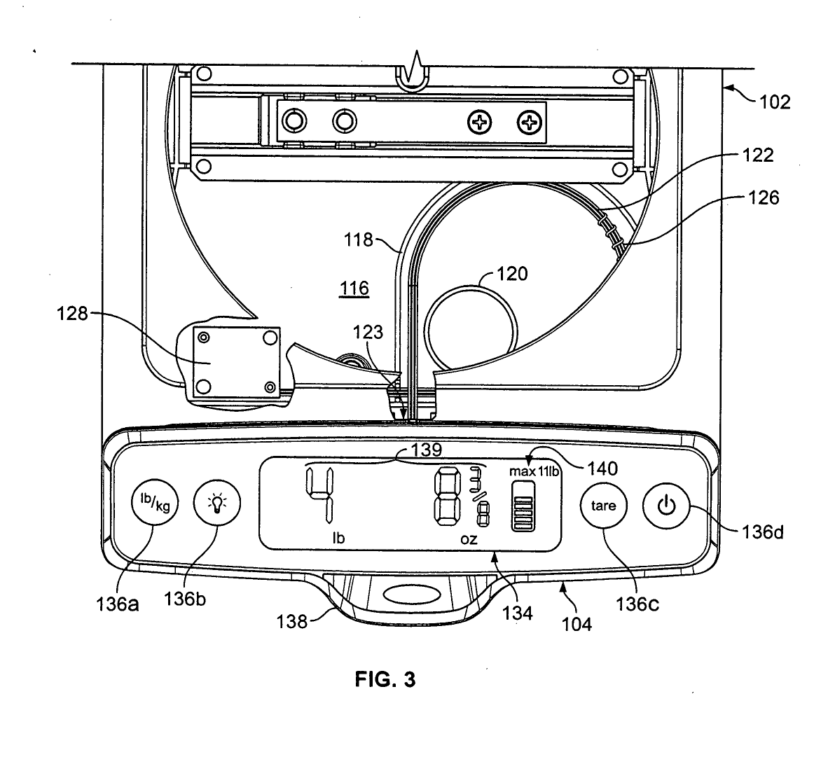

The housing 102 defines an internal compartment 116 (see FIG. 3) that is a generally open area or cavity in the base 108. The internal compartment 116 is used to store the different mechanical and electrical components of the food scale. Specifically, a guide wall 118 and a guide post 120 are integrally formed with an inside surface of the housing 102 and extend into the internal compartment or cavity 116. In the illustrated embodiment, the guide wall 118 and the guide post 120 are generally circular in shape. It should be appreciated that the guide wall 118 and the guide post 120 may be any suitable size or shape having one or more rounded portions.

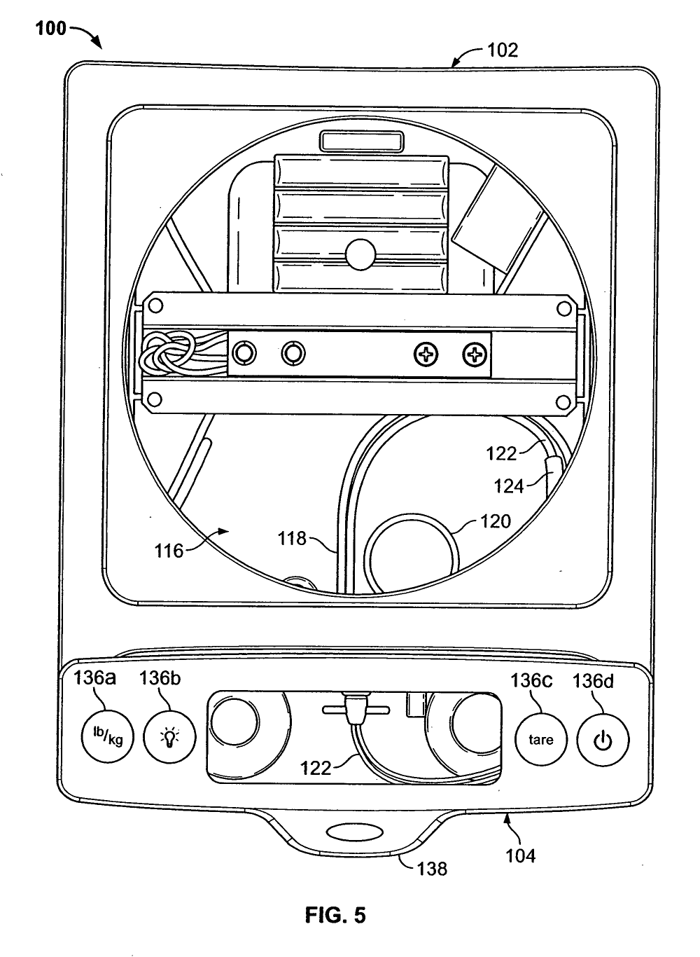

The display 104 is connected to the housing 102 by attaching one end of an electrical cord or cable 122 to the display 104 and an opposing end of the cord or cable to the housing 102. Specifically, as shown in FIG. 3, one end of the cord 122 is coupled to a processor 128 positioned in the internal compartment 116 of the housing 102. The cord or cable 122 extends from the processor 128 and around the guide post 120 being guided by the rounded shape of the guide wall 118 as shown in FIG. 5. Specifically in the illustrated embodiment, the cord 122 is wrapped 270 degrees around the post so that when the display is fully extended from the housing, the cord 122 is engaged with or positioned against the guide post 120. The friction of the cord 122 against the guide post 120 (when the display is at the fully extended position) prevents the cord from being over extended, which protects the cord and the display 104 from being damaged.

Additionally, the tendency of the cord 122 is to straighten due to the natural stiffness of the cord (similar to a spring). Therefore, when the display 104 is moved toward the housing 102 to re-attach the display to the housing, the cord 122 uncoils from the guide post 120 and provides a controlled return of the cord to the housing, which prevents the cord from binding or jamming during the retraction of the cord. It should be appreciated that the cord or cable 122 may be any suitable cord or cable for enclosing electrical wires and other similar electrical connections.

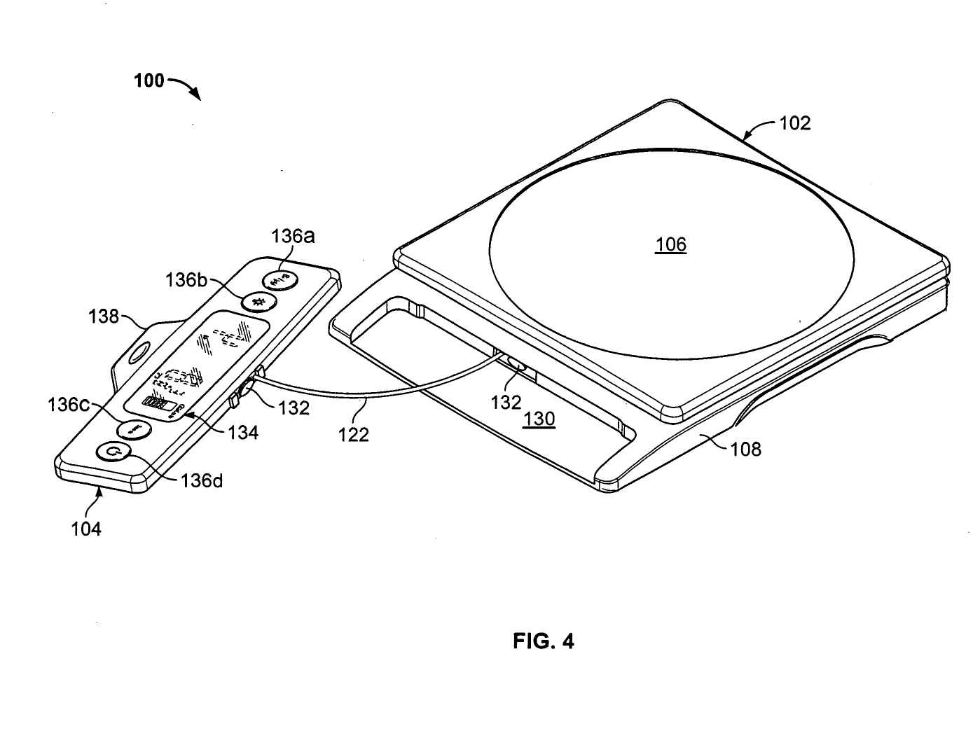

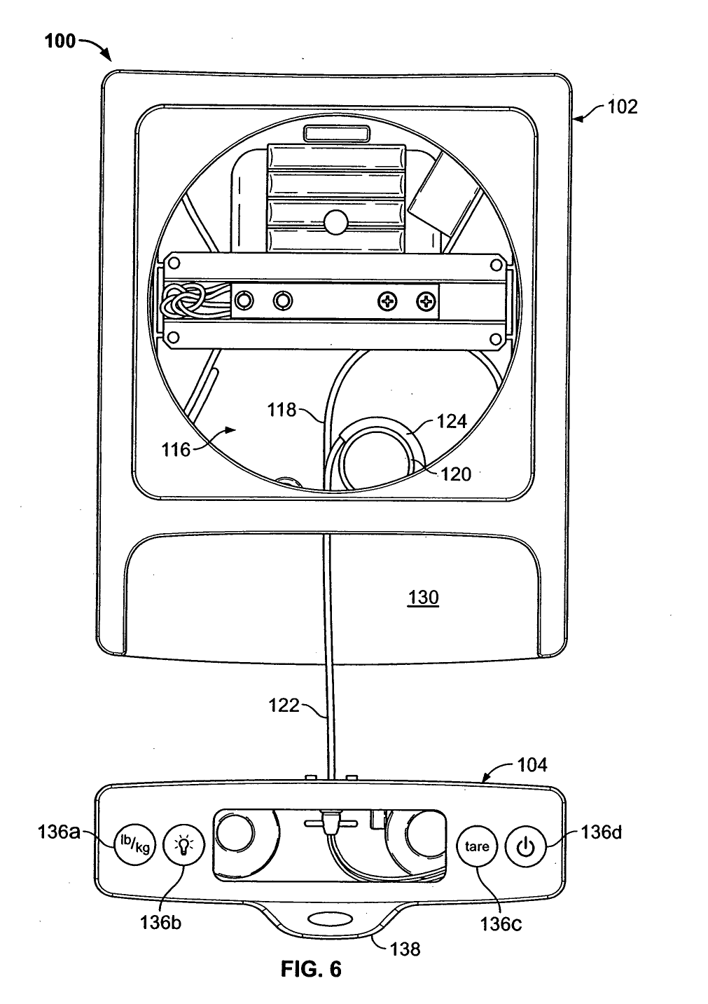

In the illustrated embodiment, the display 104 is connected to the housing 102 via the cord or cable 122. When the display 104 is removed and pulled away from the housing 102 to an extended position, as shown in FIGS. 4 and 6, a portion of the cord 122, which is stored in the internal compartment 116 of the housing 102, is pulled outwardly through the opening 123 as the display 104 moves outwardly from the housing. As shown in FIG. 6, the portion of the cord 122 which remains in the internal compartment 116 at least partially engages the guide post 120 as described above. The cord or cable 122 engages the generally rounded shape of the guide post 120 and therefore does not contact any sharp edges, points or corners of the housing which may crimp, cut, sever or otherwise damage the cord 122. Additionally, a designated portion of the cord 122 is enclosed by a sheath or covering 124 (see FIGS. 5 and 6) which helps to strengthen the integrity and durability of the cord 122 to further prevent the cord from being crimped, cut, severed or damaged. The sheath 124 may be made of any suitable material or combination of materials.

Alternatively, as shown in FIG. 3, a spring 126 may be used in place of the sheath 124. The spring 126 is a coil spring but may be any suitable spring or springs. The spring 126 helps to prevent the cord 122 from being crimped and/or damaged during use. The spring 126 also provides resiliency to the cord to help control the movement of the cord to allow the cord to more easily move into and out of the housing. The spring therefore protects the cord 122 as well as helps the cord move into and out of the internal compartment 116 of the housing 102.

As shown in FIG. 5, when the display 104 is moved to a retracted position and reattached to the housing 102, the cord is pushed back into or moves inwardly into the internal compartment 116 of the housing 102. Specifically, the portion of the cord 122 which remains in the internal compartment 116 of the housing 102, uncoils or disengages from the guide post 120 and moves at least partially into engagement with the guide wall 118. Similar to the guide post 120, the generally rounded guide wall 118 also guides the cord 122 without crimping, cutting, severing or otherwise damaging the cord. The guide wall 118 and guide post 120 therefore help to prevent the cord 122 from being crimped, cut, severed or otherwise damaged when the display 104 is removed and/or re-attached to the housing 102.

In the illustrated embodiment, the housing 102 defines a front receptacle 130 (FIG. 6) which has a size and shape that corresponds to the size and shape of the display 104. As shown in FIGS. 5 and 6, the display 104 matingly engages the receptacle 130. The walls forming the receptacle guide the display into place against the housing 102. In the illustrated embodiment, the display 104 includes one or more connectors such as magnet 132 which may be attracted to the housing 102 to help secure and hold the display 104 in position adjacent to the housing. In another embodiment, the housing 102 may be of a non-magnetic material and include at least one corresponding magnet or magnetic component 132 which is attracted to the magnet 132 of the display. It should be appreciated that the display and/or the housing may include one or a plurality of magnets.

It should be appreciated that any other suitable connectors may be used to secure and hold the display 104 on the housing 102. For example, one or more hook and loop fasteners may be used to secure the display to the housing. In another embodiment, a groove or grooves may be formed in the receptacle and on the housing 102. Corresponding protrusions or guide rails (not shown) can be molded or formed on the outer surfaces of the display so that the guide rails engage and slide along the grooves formed in the housing until the display 104 engages the housing 102.

In a further embodiment, the display 104 includes tabs (not shown) that engage slots (not shown) defined by the housing. The user then pushes or pulls on the tabs to release the tabs from the slots of the housing to be able to remove the display from the housing. It should be appreciated that any suitable connector or connectors may be used to secure and hold the display 104 on the housing 102.

In an embodiment, the display 104 includes a protruding grip 138 which enables the user to grab the display to pull it away from the housing. As shown in FIG. 3, the grip 138 is a generally protruding tab-like portion which extends generally away from the front surface of the display. It should be appreciated that the display 104 may have one or more grips or grip portions to enable the user to sufficiently grasp and pull the front display away from the housing 102.

As shown in FIG. 3, the display 104 displays or shows the weight measurements of the food items placed on the food scale. Specifically, the display 104 includes a screen 134, which has a generally rectangular shape, and which has a weight indicator 139 that displays the weight of a food item in English units, such as in pounds and ounces, or in metric units, such as in kilograms and grams, as further described below. It should be appreciated that suitable unit or units may be displayed by the screen 134.

In the illustrated embodiment, the screen 134 is a light emitting diode (L.E.D.) screen. It should be appreciated that the screen 134 may be any suitable screen or screens which is able to display the weight measurements to a user. In the illustrated embodiment, the screen 134 includes a maximum or threshold weight indicator 140 which indicates a designated weight such as a designated maximum weight for the food scale. The maximum weight indicator 140 shows the maximum weight of the food scale, which in the example is eleven pounds. The maximum weight indicator 140 also displays or illuminates one or more horizontal lines or boxes to provide a different visual indicator as to the overall weight of the item or items on the food scale compared to the designated maximum weight of the scale. In an embodiment, the maximum weight indicator 140 indicates when the weight of the item nears a designated weight such as the designated maximum weight. In another embodiment, the maximum weight indicator indicates when the weight of the item exceeds a designated weight. It should be appreciated that the maximum weight indicator 140 may include any suitable comparison indicator or indicators which show the relationship between the present weight of the items on the food scale and a designated weight.

The display 104 also includes a plurality of buttons 136 that perform different functions. For example, button 136a toggles the displayed weight on the screen 134 between English units and metric units. It should be appreciated that any suitable type of unit or units may be displayed on the screen and the button 136a may toggle between one or a plurality of the different units. The button 136b is a back light button as indicated by the “light bulb” symbol shown on the button. The back light button 136b illuminates the screen 134 to make the numbers and/or other objects displayed on the screen more visible to a user. The button 136c is a “tare” button which initially counts the weight of a bowl or other container, paper or other item that is placed on the scale to hold one or more food items being weighed by the scale. The tare button 136c records the measurement of the container, paper or other item placed on the food scale 100 prior to placing the food item or items on the food scale. The weight of the container, paper or other item is then subtracted from the weight of the food item(s) plus the container or paper to provide the weight of the food items or items on the screen 134.

The button 136d is the power button and allows the food scale to be turned “on” and “off.” It should be appreciated that the food scale 100 may include one or a plurality of buttons to provide a variety of functions. It should also be appreciated that the symbol or object displayed on the buttons may be any suitable symbol or object, or any suitable object or objects.

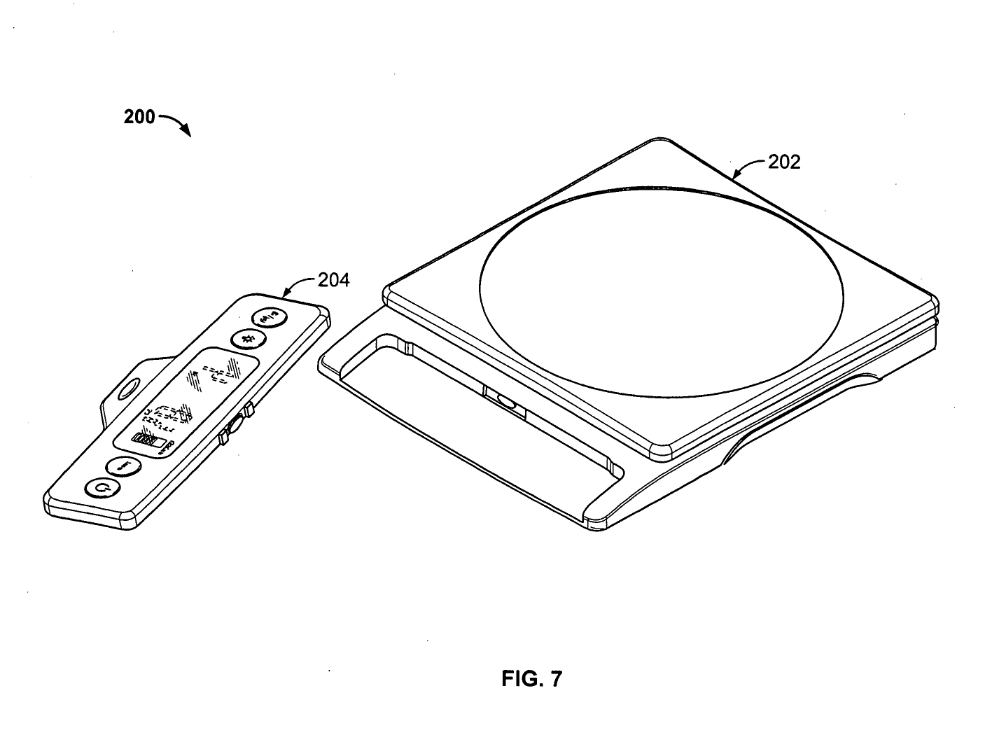

FIG. 7 shows a wireless embodiment which is similar to the embodiment described above, except that instead of a corded connection between the housing and the display, the housing 202 includes a suitable wireless signal generator or transmitter (not shown) and the display 204 includes a suitable wireless signal receiver (not shown). The transmitter and receiver may use infrared, radio or other suitable wireless media.

It should be appreciated that the above embodiments of the food scale 100 may be made of any suitable material or combination of materials.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

The invention is claimed as follows:

1. A scale comprising:
a housing including a weight sensor, said weight sensor adapted to determine a weight of an item placed on said weight sensor; and
a display communicating with said weight sensor and removably attached to said housing, said display being adapted to display said weight of said item, said display including at least one connector, wherein said connector is attached to said housing to secure the display to the housing.

2. The scale of claim 1, wherein said housing includes a wireless signal generator and said display includes a wireless signal receiver, and wherein said wireless signal generator generates a signal corresponding to the weight of the item and said wireless signal receiver receives the signal and displays the weight of the item.

3. The scale of claim 1, which includes a cord connected to said weight sensor and said display.

4. The scale of claim 1, wherein said display includes an indicator which indicates when the weight of the item nears a designated weight.

5. The scale of claim 1, wherein said display includes an indicator which indicates when the weight of the item exceeds a designated weight.

6. The scale of claim 1, wherein said item is a food item.

7. The scale of claim 1, wherein said connector includes at least one magnet that is attracted to said housing.

8. The scale of claim 1, wherein said connector and said housing each include at least one magnet, and wherein said magnet of said connector is attracted to said magnet of said housing.

9. A scale comprising:
a housing including a weight sensor adapted to determine a weight of an item placed on said weight sensor, said housing defining an internal compartment and including at least one guide post and at least one guide wall in said internal compartment,
a display removably attached to said housing, said display adapted to display said weight of said item and being movable between an extended position and a retracted position; and
a cord connected to said housing and said display to communicate signals between said housing and said display, said guide post and said guide wall being configured to help guide the cord when the display is moved between the extended position and the retracted position and to prevent crimping of the cord, said cord being stored in said internal compartment when said display is in the retracted position.

10. The scale of claim 9, wherein said display includes an indicator which indicates when the weight of the item nears a designated weight.

11. The scale of claim 9, wherein said display includes an indicator which indicates when the weight of the item exceeds a designated weight.

12. The scale of claim 9, wherein said item is a food item.

13. The scale of claim 9, wherein said display includes at least one magnet that is attracted to said housing.

14. The scale of claim 9, wherein said display and said housing each include at least one magnet, and wherein said magnet of said display is attracted to said magnet of said housing.

15. A scale comprising:
a housing including a weight sensor, said weight sensor adapted to determine a weight of an item placed on said weight sensor; and
a display communicating with said weight sensor and removably attached to said housing, said display adapted to display said weight of said item and including an indicator which indicates a relationship between said weight of said item and a designated weight.

16. The scale of claim 15, wherein said housing includes a wireless signal generator and said display includes a wireless signal receiver, and wherein said wireless signal generator generates a signal corresponding to said weight of said item and said wireless signal receiver receives the signal and displays said weight of said item.

17. The scale of claim 15, wherein said indicator indicates when said weight of said item exceeds said designated weight.

18. The scale of claim 15, wherein said item is a food item.

19. The scale of claim 15, wherein said display includes at least one magnet that is attracted to said housing.

20. The scale of claim 15, wherein said display and said housing each include at least one magnet, and wherein said magnet of said display is attracted to said magnet of said housing.
